(19) United States
(12) Patent Application Publication
(10) Pub. No.: US 2013/0003651 A1
(43) Pub. Date: Jan. 3, 2013

(54) TELECOMMUNICATION SYSTEM COMPRISING A CENTRAL IP ROUTER COMPOSED OF A SATELLITE AND OF A GROUND ROUTER

(75) Inventors: Fabrice HOBAYA, TOURNEFEUILLE (FR); Cédric BAUDOIN, TOULOUSE (FR); Emmanuel CHAPUT, LAUNAGUET (FR); Patrick GELARD, CASTANET (FR)

(73) Assignees: CENTRE NATIONAL D'ETUDES SPATIALES (CNES), PARIS CEDEX 01 (FR); THALES, NEUILLY SUR SEINE (FR)

(21) Appl. No.: 13/539,397

(22) Filed: Jun. 30, 2012

(30) Foreign Application Priority Data
Jun. 30, 2011 (FR) 1102034

(51) Int. Cl. H04B 7/185

(52) U.S. Cl. 370/316

(57) ABSTRACT

The subject of the invention is a satellite comprising at least one central router, a source terminal and a destination terminal. The source terminal comprises means for transmitting, via the central router, IP packets fragmented into at least one level-2 fragment to the destination terminal to which a destination IP address is allocated. The said central router is composed of a satellite and of a ground router. The satellite comprises means for implementing a switching of the IP packets without reassembling the level-2 fragments sent by the source terminal to the destination terminal, the said fragments comprising a reference to the Destination IP address used as basis for the switching. The ground router comprises means for determining IP routing parameters, the said parameters being transmitted by the ground router to the satellite so as to configure the way in which the switching is carried out by the said satellite.

### CROSS-REFERENCE TO RELATED APPLICATIONS

This application claims priority to foreign French patent application No. FR 11 02034, filed on Jun. 30, 2011, the disclosure of which is incorporated by reference in its entirety.

### FIELD OF THE INVENTION

The invention relates to a telecommunication system comprising a central IP router composed of a satellite playing the role of IP switch and of a ground router making it possible to carry out the other routing functions. It applies notably to the fields of satellite communications.

### BACKGROUND OF THE INVENTION

There exist today satellite telecommunication systems composed of one or more satellites comprising an onboard IP router and allowing terminals to communicate with one another without passing through a terrestrial relay.

In this description, a terminal denotes any item of equipment comprising means for receiving and sending data originating from another item of equipment via one or more satellites belonging to the system. Thus a terminal may be a server, a laptop computer, an aircraft or any type of item of equipment meeting this definition.

An onboard IP router carried by a satellite makes it possible to obtain flexibility in terms of IP addressing plane. Moreover, the complexity of the terminals of the system communicating with the said satellite is reduced. Furthermore, the double-voucher phenomenon is avoided for performing the IP routing since an intermediate terminal, playing the role of gateway, is not required. Moreover, the volume of routing signaling generated on the satellite segment is reduced, as is the convergence time of the routing tables for the terminals of the system.

The processing operations and computations performed by the satellite are implemented by at least one onboard processing unit customarily denoted by the acronym OBP standing for the expression “On Board Processor”. The existing systems using an onboard IP router require a level-3 OBP. In the description, levels 2 and 3 refer to the levels of the OSI reference model, the acronym standing for the expression “Open Systems Interconnection”.

An exemplary system comprising an onboard IP router carried within a satellite is the CLEO system, the acronym standing for the expression “Cisco router in Low Earth Orbit”. This experimentation system carries onboard a conventional IP router on a secondary payload of a flyby satellite. Another system denoted by the acronym IRIS standing for the expression “Internet Routing in Space Router” has thereafter been implemented, the said system making it possible to interconnect terminals via an onboard IP router within an Intelsat IS-14 geostationary satellite. This router has the same functionalities and the same capacities as a terrestrial IP router but it can be carried aboard the satellite.

A drawback of this type of system is that an IP router onboard a satellite is difficult to achieve in practice. Indeed, considerable hardware resources are required, notably in terms of memories and computation power. Now, the onboard payload carried in a satellite is limited. Consequently, the existing solutions can only support limited bitrates.

### SUMMARY OF THE INVENTION

An aim of the invention is notably to alleviate the aforementioned drawbacks.

For this purpose the subject of the invention is a telecommunication system comprising at least one central router, a source terminal and a destination terminal. The source terminal comprises means for transmitting, via the central router, IP packets fragmented into at least one level-2 fragment to the destination terminal to which a destination IP address is allocated. The said central router is composed of a satellite and of a ground router, the said satellite comprising means for implementing a switching of the IP packets without reassembling the level-2 fragments sent by the source terminal to the destination terminal. The fragments comprise a reference to the Destination IP address used as basis for the switching. The ground router comprises means for determining useful IP routing parameters for implementing the IP switching, the said parameters being transmitted by the ground router to the satellite so as to configure the way in which the switching is carried out by the said satellite.

The reference to the Destination IP address is the Destination IP address itself.

In one embodiment, the reference to the Destination IP address is a reference label.

According to one aspect of the invention, the reference label is added to the header of the level-2 fragments by the source terminal.

According to another aspect of the invention, the size of the first level-2 fragment of an IP packet after fragmentation is at least equal to the size of the level-2 header plus the size of the IP header.

The satellite records for example the association between the IP switching label and the Destination IP address with the passage of the first level-2 fragment of an IP packet.

The size of the IP switching label is for example 1 byte.

An IP switching label corresponds for example to a local variable specific to each terminal.

According to one aspect of the invention, the information items relating to the IP routing and to the IP switching are stored in the ground router in the form of tables.

The satellite can comprise a routing table for the satellite, the said table containing the destination IP address, a mask when it entails a network address, the number of the associated output port and the level-2 address of a gateway.

In one embodiment, the satellite decrements the TTL field of the IP header during the passage of the first level-2 fragment.

The DVB-S2 and DVB-RCS2 technologies may be used within the framework of the invention.

The subject of the invention is also a communication satellite comprising means for implementing a switching of IP packets without reassembling the level-2 fragments sent by a source terminal to a destination terminal, the said fragments comprising a reference to the Destination IP address used as basis for the switching.

The subject of the invention is also a ground router comprising means for determining IP packet routing parameters, the said parameters being transmitted by the ground router to the satellite carrying out the IP packet switching.

### BRIEF DESCRIPTION OF THE DRAWINGS

Other characteristics and advantages of the invention will become apparent with the aid of the description which follows given by way of nonlimiting illustration, offered with regard to the appended drawings among which:

FIG. 1 presents a high-level architecture of the system according to the invention;

FIG. 2 gives an exemplary central router according to the invention;

FIG. 3 gives an exemplary control plane protocol architecture for a satellite system using the DVB-S2 and DVB-RCS2 technologies;

FIG. 4 gives an exemplary data plane protocol architecture for a satellite system using the DVB-S2 and DVB-RCS2 technologies;

FIG. 5 gives an exemplary management plane protocol architecture for a satellite system using the DVB-S2 and DVB-RCS2 technologies.

### DETAILED DESCRIPTION

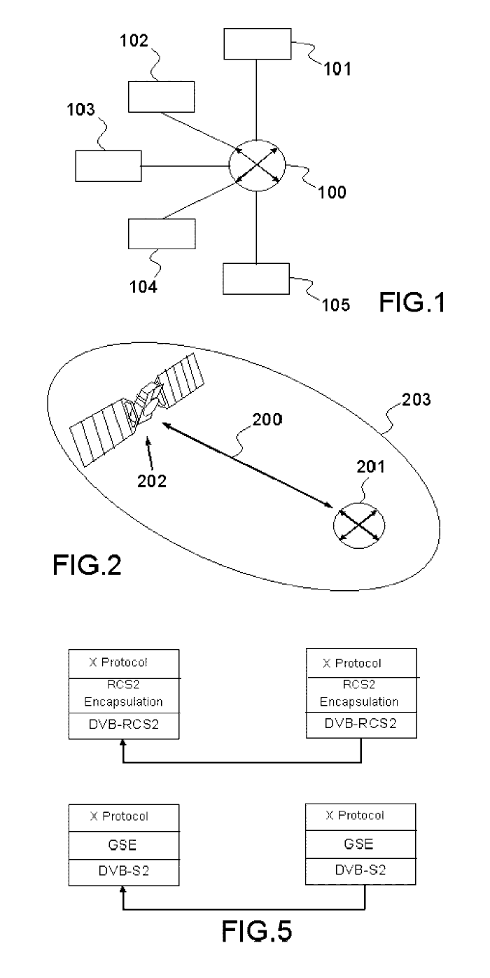

FIG. 1 presents a high-level architecture of the system according to the invention.

The system according to the invention is a system making it possible to enable a plurality of terminals and of servers 101, 102, 103, 104, 105 to communicate with one another by way of at least one communications satellite. The principle of the invention is that the satellite emulates an IP router. Stated otherwise, the satellite is perceived by the terminals of the system as an IP router although the latter does not implement all the functionalities of a traditional IP router.

This emulation is rendered possible notably by separating the IP switching and IP routing functions. The architecture of the system is based on a central router 100 split into two entities allowing the emulation of the IP router.

The first entity implements the IP switching and is implemented at the satellite level. This makes it possible to avoid transit of the data via the ground during the transfer of packets from one terminal to the other via the satellite. The phenomenon of double hop is then avoided. The first entity therefore corresponds to a level-2 OBP included in the satellite with an IP switching function.

The second entity implements the IP routing, that is to say the management of the routing signaling and the computation of the routes. It is situated for example in a ground station thereby making it possible to reduce the necessary resources onboard the satellites.

This separation of the IP router into two functional entities apportioned respectively within the satellite and within a ground router makes it possible furthermore to carry out the IP switching aboard the satellite without reassembling the IP packets. Accordingly, a reference label to the destination IP address is added to each fragment of the level-2 packet.

Advantageously, the system according to the invention makes it possible to offer functionalities identical to those of an onboard IP router, the ground terminals behaving as if they were connected to an onboard IP router. The complexity of the computations to be carried out aboard the satellite as well as the necessary memory resources are reduced thereby making it possible for constant resources to increase the bitrates supported in relation to existing systems.

FIG. 2 gives an exemplary central router according to the invention. On account of the separation of the central router into two physical entities, exchanges 200 will therefore take place between the ground router 201 and the satellite 202. After having computed the routing table, the ground router 201 will dispatch the information items necessary to the satellite 202 so that the latter can achieve the IP switching. The ground router 201 may be located in a fixed or mobile terrestrial station or else in an aircraft, the term ‘ground’ being used to signify that the said router is implemented in a distinct item of equipment from the satellite.

This architecture of the central IP router therefore makes it possible to lighten the payload of the satellite in comparison with a level-3 OBP implementing all of the functions of an IP router. The necessary onboard resources are then significantly reduced.

The system according to the invention must manage signaling transmission as well as data transmission. In order to describe the invention more precisely, the principles of the control plane and of the data planes necessary for the implementation of the invention are presented. Moreover, examples of protocol architecture based on the DVB-S2 and DVB-RCS2 systems are presented. It should be noted that the invention may be implemented on the basis of other satellite technologies.

The objective of the control plane is notably to implement the routing protocol as well as the announcing of the routes. The entities involved in the routing protocol are described hereinafter.

The terminals and the ground router build in an interior routing protocol IGP, the acronym standing for the expression “Interior Gateway Protocol”. An exterior routing protocol EGP, the acronym standing for the expression “Exterior Gateway Protocol”, can also be used. As mentioned previously, a satellite of the system according to the invention does not build in any routing protocol. This makes it possible to reduce the complexity of the payload of the satellite. Various routing protocols may be used within the framework of the invention, such as for example the RIP protocol, the acronym standing for the expression “Routing Information Protocol”, the OSPF protocol, the acronym standing for the expression “Open Short Path First” or the BGP protocol, the acronym standing for the expression “Border Gateway Protocol”.

With regard to the announcements of routes from the terminals to the central router, the terminals announce routes to the central router as if it entailed just one and the same entity. In reality, the satellite 202 will simply switch the route announcements to the ground router 201, doing so without interpreting them.

Moreover, the ground router computes the routing table and configures the satellite. The ground router then integrates all the routing information items which are transmitted to it and computes the routing table arising therefrom. It is thereafter the ground router which configures the satellite so that it can achieve the IP switching. Accordingly, the ground router will provide IP level switching information items to the satellite, that is to say the information items contained in the routing table computed by the ground router.

With regard to the announcing of the routes from the central router to the terminals, the ground router dispatches routing information items to the terminals, which receive these information items as if they originated from an IP router onboard the satellite. The terminals then update their routing table as a function of the information items which arrive thereat on the air interface.

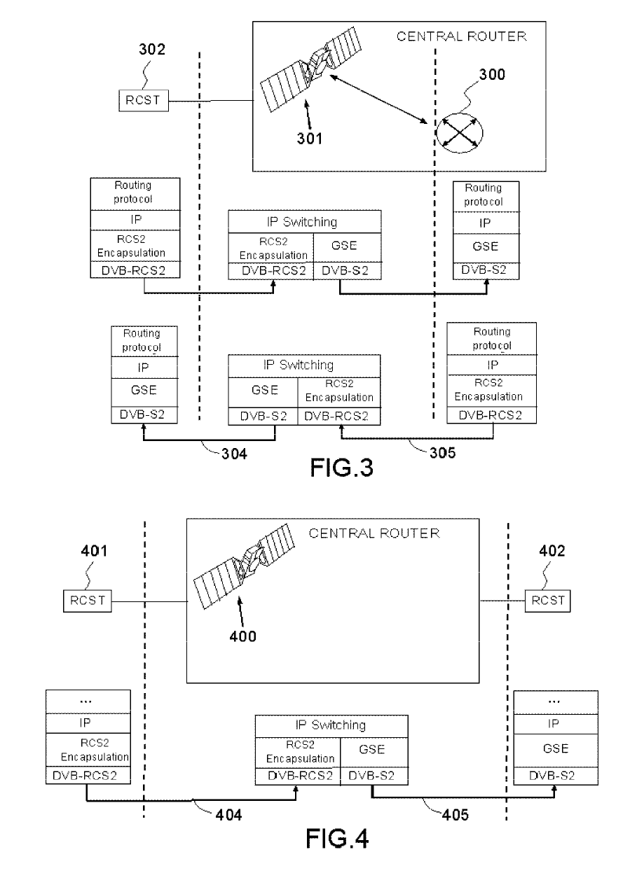

FIG. 3 gives an exemplary control plane protocol architecture for a satellite system using the DVB-S2 and DVB-RCS2 technologies. Indeed, the system according to the invention may be implemented by using the DVB-S2 satellite communication standard for broadcasting and the DVB-RCS2 satellite communication standard for the return pathway. However, the invention is not limited to these standards and may be implemented using other satellite technologies, based on geostationary or non-geostationary satellites.

In this exemplary control plane architecture, only the routing signaling is considered. Directly involved in the signaling of the routing are the terminals 302 denoted by the acronym RCST standing for the expression “Return Channel Satellite Terminal” and the ground router 300 which send and receive routing information.

The radio downlink 304 relies on a DVB-S2 physical layer and the radio uplink on a DVB-RCS2 physical layer. The data link layer relies for example on the DVB-RCS2 encapsulation protocol and on the GSE protocol, the acronym standing for the expression “Generic Stream Encapsulation”. The DVB-RCS2 encapsulation protocol is used for the uplinks. The GSE protocol is used for the downlinks.

The IP switching is implemented at the satellite level. The routing protocol used is implemented both at the ground router 300 level and the RCST terminals level. This exemplary architecture is independent of the routing protocol chosen.

The satellite 300 is indirectly involved in the guise of level-2 element linking the terminals to the ground router. Indeed the routing information passes through the satellite, but the latter does not send and does not manage any routing information.

As regards the data plane, the IP switching is carried out aboard the satellite without reassembly of the IP packets.

The objective is therefore to carry out the switching onto the destination IP address without reassembling the packet. Accordingly, labels at level 2 refer to the level-3 destination address, that is to say the destination IP address. The necessary onboard resources in terms of memory and computation are then reduced. Indeed, the storage of the fragments of all the IP packets undergoing switching demands considerable memory resources. Moreover the reassembly and the re-fragmentation of these IP packets demands considerable computational resources. Performing these operations in a terrestrial station is not problematic since the memory resources and the computational resources are less constrained than in a satellite. Moreover, in contradistinction to terrestrial networks where the fragmentation of the IP packets is almost nonexistent, this fragmentation is almost routine within the satellite context since the small sizes of the level-2 PDUs do not allow the transport of IP packets without fragmentation, the acronym PDU standing for the expression “Protocol Data Unit”.

FIG. 4 gives an exemplary data plane protocol architecture for a satellite system using the DVB-S2 and DVB-RCS2 technologies.

In the data plane, the terminals 401, 402 and the satellite 400 are involved but not the ground router, the said data not passing through the ground router. Thus, the ground router is not represented in the figure.

To be able to carry out the IP switching without reassembly of the IP packets, it is necessary that the Destination IP address or at least a reference to the latter is present in each level-2 fragment.

In order not to have too considerable a header size in relation to the size of the data contained in a packet, it will be chosen to use a label of relatively small size in each level-2 fragment, the said label being used to refer to the Destination IP address. Indeed, if the IP address were used directly, it would be necessary to provide for 4 bytes in the IPv4 case and 16 bytes in the IPv6 case for each level-2 fragment. It is proposed within the framework of the invention to use a label of relatively small size, for example less than or equal to 4 bytes. This size can vary depending on technology. For its part, the satellite comprises means for matching a label with a destination IP address and with an output port.

In order to explain the operation of the IP switching without onboard reassembly, the example of an IP packet sent from a terminal called the source terminal to another terminal called the destination terminal via the satellite is given hereinafter. This packet is fragmented into several level-2 fragments, i.e. a first fragment, intermediate fragments and a last fragment. In all the fragments is placed an identical label called the IP switching label, the said label referring to the Destination IP address. Stated otherwise, a level-3 information item is introduced into the header of the level-2 fragment.

The transmission of the level-2 fragments from the source terminal to the destination terminal takes place as follows.

With regard to the dispatching of the first fragment, the latter contains inter alia the IP switching label as well as the header of the IP packet and optionally a part of the data. It is dispatched to the satellite by the source terminal. With the passage of this fragment, the satellite records the association between the IP switching label and the Destination IP address. It thereafter switches the fragment to the destination terminal by using the information items with which it was provided by the ground router such as the output port number.

It should be noted that the minimum size of the first fragment will be given by the level-2 header plus the level-3 header, that is to say the IP header.

The intermediate fragments are thereafter dispatched by the source terminal. With the passage of the intermediate fragments, the satellite reads the IP switching label and can therefore deduce therefrom the destination IP address, although the latter is not explicitly present, so as to be able to switch these fragments correctly.

Finally, with the passage of the last fragment, the satellite switches the fragment and erases the association between label and Destination IP address that it had recorded.

From the point of view of the terminals, everything has taken place as if an onboard IP router had reassembled the IP packet and then routed the latter as a function of the destination IP address.

FIG. 5 gives an exemplary management plane protocol architecture for a satellite system using the DVB-S2 and DVB-RCS2 technologies.

The management plane is dedicated for example to the transfer of information from the ground router to the satellite for its configuration.

The entities involved are solely the satellite and the ground router. The protocol stacks of the uplink and downlink between the ground router and the satellite are illustrated.

The architecture of the management plane is given by way of demonstration.

In the subsequent description an exemplary IP switching label is given. An exemplary scheme for managing the labels by the sender terminals is also proposed. The information items stored in the central router, that is to say in the ground router 201 and in the satellite 202, are thereafter detailed. Also explained are the way in which the satellite IP switching table is managed and how the packets are switched by the satellite.

The IP switching label of this example has a size of 1 byte. This label is used to refer to the destination IP address. The size of this additional header field is reduced in comparison with a full IP address, IPv4 or IPv6 for example. By way of remark, this length of 1 byte is sufficient since the maximum number of IP packets which may be fragmented in parallel by a terminal is 8. This limitation is due to length of 3 bits of the level-2 fragment identification field (Frag_ID field) of DVB-RCS2.

In order to avoid complex signaling between the terminals, a label corresponds for example to a local variable specific to each terminal. Two terminals will therefore be able to use the same label at one and the same instant to refer to two distinct destination IP addresses. To be able to deduce the destination IP address of a level-2 fragment, the satellite will have to read the label and the level-2 source address.

By considering the level-2 protocol of DVB-RCS2, the label is then placed in the fragment_label field of the fragments of DVB-RCS2. This field corresponds to the level-2 addressing. Here there will therefore be a part of the level-2 header, that is to say the field normally dedicated to the level-2 addressing, which will in fact refer to a level-3 information item. This level-3 information item referred to is the destination IP address. It may be noted that this implementation runs counter to the principles stated by virtue of the OSI reference model. This deviation from the reference model makes it possible to achieve switching on level-2 elements with a level-3 information item.

The ground router 201 is not directly involved in the mechanisms making it possible to achieve onboard IP switching without reassembly. However, it is the ground router that configures the satellite 202 which is in charge of the IP switching. The information items relating to the IP routing and to the IP switching are, for example, stored in the ground router in the form of tables.

In a preferred embodiment, the ground router will have two tables in memory. A first table is termed ARP, the acronym standing for the expression “Address Resolution Protocol” and a routing table.

The ARP table makes it possible to match level-2 addresses with corresponding level-3 addresses.

The routing table is filled by the routing protocol used on the satellite segment. It contains for example 4 customary items of information:
the destination IP address corresponding for example to a machine address or to a network address;
a mask if it entails a network address;
the gateway (that is to say the IP address of the next router to be attained so as to reach the destination);
the output port, for example a spot number within the context of satellite systems.

The satellite can have both tables in memory. The first table is called the satellite routing table and the second table is called the IP switching table.

The satellite routing table corresponds for example to a fusion of the two tables of the ground router, i.e. the routing table and the ARP table. To achieve the IP switching, the satellite will not need all the information items included in the routing table stored in the ground router. The satellite routing table will contain the destination IP address, the mask if it entails a network address, the number of the associated output port and the level-2 address of the gateway. This table is filled and updated as a function of the information dispatched by the ground router.

The IP switching table contains for example four types of information:
a level-2 source address;
the IP switching label;
the level-2 destination address;
the output port number.

A [level-2 source address, IP switching label] information pair constitutes an input pair of the table making it possible to find an output pair [the level-2 destination address, output port number].

If a satellite has to switch a level-2 fragment, it will read in its header the level-2 source address of the fragment together with the label and will then consult its IP switching table so as to be able to switch the IP packet onto the appropriate output port and with the appropriate level-2 destination address.

The implementation of these tables may be optimized to minimize the necessary memory space by avoiding redundancies of information, in particular as regards level-2 destination addresses and output port numbers.

As explained previously, the labels may be managed independently from one terminal to the other. This makes it possible to avoid the implementation of a mechanism of synchronization between the terminals and therefore to avoid additional signaling.

Moreover any IP router must in theory decrement the TTL field present in the IP address with the aim of preventing a lost packet from looping indefinitely. It is therefore possible that the satellite might decrement the TTL field during the passage of the first fragment of an IP packet which contains the whole of the IP header. The satellite will then have to update the checksum of the header, this being simple since only the TTL field has been decremented.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

1. A telecommunication system comprising:
at least one central router comprising a satellite and a ground router;
a source terminal; and
a destination terminal, wherein
the source terminal comprises means for transmitting, via the central router, IP packets fragmented into one or more one level-2 fragments to the destination terminal to which a destination IP address is allocated;
the satellite comprising means for switching of the IP packets without reassembling the level-2 fragments sent by the source terminal to the destination terminal;
the fragments comprise a reference to a Destination IP address used as a basis for the switching; and
the ground router comprises means for determining IP routing parameters, the parameters being transmitted by the ground router to the satellite so as to configure the way in which the switching is carried out by the satellite.

2. The telecommunication system according to claim 1 wherein the reference to the Destination IP address is the Destination IP address itself.

3. The telecommunication system according to claim 1 wherein the reference to the Destination IP address is a reference label.

4. The telecommunication system according to claim 3 wherein the reference label is added to the header of the level-2 fragments by the source terminal.

5. The telecommunication system according to claim 3 wherein the size of the first level-2 fragment of an IP packet after fragmentation is at least equal to the size of the level-2 header plus the size of the IP header.

6. The telecommunication system according to claim 5 wherein the satellite records an association between the IP switching label and the Destination IP address with the passage of the first level-2 fragment of an IP packet.

7. The telecommunication system according to claim 3 wherein the size of the IP switching label is 1 byte.

8. The telecommunication system according to claim 3 wherein an IP switching label corresponds to a local variable specific to each terminal.

9. The telecommunication system according to claim 1 wherein the information items relating to the IP routing and to the IP switching are stored in the ground router in the form of tables.

10. The telecommunication system according to claim 9 wherein the satellite comprises a routing table for the satellite, the table containing the destination IP address, a mask when it entails a network address, the number of the associated output port, and the level-2 address of a gateway.

11. The telecommunication system according to one of the preceding claims in which the satellite decrements the TTL field of the IP header during the passage of the first level-2 fragment.

12. The telecommunication system according to claim 1 in which the DVB-S2 and DVB-RCS2 technologies are used.

13. A communication satellite comprising means for implementing a switching of IP packets without reassembling the level-2 fragments sent by a source terminal to a destination terminal, the fragments comprising a reference to the Destination IP address used as basis for the switching.

14. A ground router comprising means for determining IP packet routing parameters, the parameters being transmitted by the ground router to the satellite carrying out the IP packet switching.
